(19) United States
(12) Patent Application Publication
(10) Pub. No.: US 2022/0198193 A1
(43) Pub. Date: Jun. 23, 2022

(54) INFORMATION DISPLAY DEVICE, INFORMATION DISPLAY METHOD AND PROGRAM

(71) Applicant: KDDI CORPORATION, Tokyo (JP)

(72) Inventors: Tomoaki MATSUKI, Tokyo (JP); Sou YAMAZAKI, Tokyo (JP); Kyohei TSUJI, Tokyo (JP)

(73) Assignee: KDDI CORPORATION, Tokyo (JP)

(21) Appl. No.: 17/411,686

(22) Filed: Aug. 25, 2021

(30) Foreign Application Priority Data
Dec. 23, 2020 (JP) 2020-213770

(51) Int. Cl. G06K 9/00; G06T 7/50; G06T 15/00; G06T 7/70; G06F 3/14; G06T 11/00

(52) U.S. Cl. CPC G06K 9/00671; G06T 7/50; G06T 11/00; G06T 7/70; G06F 3/14; G06T 15/00

(57) ABSTRACT

An information display device includes: an acquisition unit that acquires a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; and a display control unit that causes a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions, wherein the display control unit causes the display unit to display the sensing data acquired by sensing the sensed object at each of the sensing positions so as to be superimposed on a terrain image corresponding to each of the sensing positions.

### BACKGROUND OF THE INVENTION

### Field of the Invention

The present invention relates to an information display device for displaying information, an information display method and a program.

Priority is claimed on Japanese Patent Application No. 2020-213770, filed Dec. 23, 2020, the content of which is incorporated herein by reference.

### Description of Related Art

In recent years, the use of so-called drones has become widespread. Japanese Unexamined Patent Application, First Publication No. 2016-174360 discloses a technique for displaying an image captured by a camera of a flight-type drone camera on a device.

### SUMMARY OF THE INVENTION

The above-described technique is used, such that a user can confirm a subject included in an image displayed on a device. However, it may be difficult for the user to grasp where the subject included in the image displayed on the device exists. Therefore, it is required for the device to display the image captured by a camera of a drone so that the user easily grasps the image (hereinafter, referred to as “sensed information”).

The present invention has been made in view of these points, and an object of the present invention is to provide an information display device capable of visually grasping the sensed information, an information display method and a program.

According to a first aspect of the present invention, an information display device includes: an acquisition unit that acquires a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; and a display control unit that causes a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions, wherein the display control unit causes the display unit to display the sensing data acquired by sensing the sensed object at each of the sensing positions so as to be superimposed on a terrain image corresponding to each of the sensing positions.

The display control unit may cause the display unit to display the directional information for indicating the direction of the sensed object at each of the sensing positions so as to be further superimposed on the terrain image corresponding to each of the sensing positions.

The sensing data may be an image captured by the sensor.

The sensing data may include information measured by the sensor and indicating a distance from the sensor to the sensed object.

The acquisition unit may acquire the sensing data, the sensing positions at which the sensing data are acquired and the directional information from the flying device while the flying device flies.

The display control unit may further cause the display unit to display the sensing data, the sensing positions and the directional information in response to the acquisition unit acquires the sensing data, the sensing positions and the directional information as a trigger.

The display control unit may cause the display unit to display the sensing data acquired by sensing the sensed object specified by a user among the plurality of the sensing data.

The acquisition unit may further acquire information indicating a flight route that the flight device has flown; and the display control unit may cause the display unit to display the flight route so as to be further superimposed on the terrain image.

The display control unit may cause the display unit to display the flight route in a three-dimensional manner.

The display control unit may cause the display unit to further display information relating to the sensed object.

The display control unit may cause the display unit to further display latitude, longitude, and altitude indicated by each of the sensing positions.

The display control unit may further cause the display unit to display at least one of weather when the sensing data is acquired and a state of the flight device.

The acquisition unit may acquire the sensing data, the acquisition position, and the directional information from the flight device in flight, and the information display device may further comprise an information management unit that causes a storage unit to store the sensing data, the acquisition position, and the directional information in association with each other.

The terrain image may be either a map data display image or a computer graphics display image.

According to a second aspect of the present invention, an information display method executed by a computer includes: acquiring a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; causing a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions; and causing a display unit to display the sensing data acquired by sensing the sensed object at each of the sensing positions so as to be superimposed on a terrain image corresponding to each of the sensing positions.

According to a third aspect of the present invention, a non-transitory computer-readable medium storing a program for causing a computer to function as: an acquisition unit that acquires a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; and a display control unit that causes a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions, wherein the program causes a computer to further function as the display control unit that causes the display unit to display the sensing data acquired by sensing the sensed object at each of the sensing positions so as to be superimposed on a terrain image corresponding to each of the sensing positions.

According to the present invention, it is possible to easily grasp the sensed information visually.

### BRIEF DESCRIPTION OF THE DRAWINGS

FIG. 1 is a diagram illustrating an outline of an information display system according to an embodiment of the present invention.

FIG. 2 is a diagram schematically illustrating information displayed on an information display device according to the embodiment of the present invention.

FIG. 3 is a block diagram illustrating the information display device according to the embodiment.

FIG. 4 is a diagram schematically illustrating information displayed on the information display device according to the embodiment.

FIG. 5 is a sequence chart illustrating a processing of the information display system according the embodiment.

### DETAILED DESCRIPTION OF EMBODIMENTS

### Outline of Information Display System S

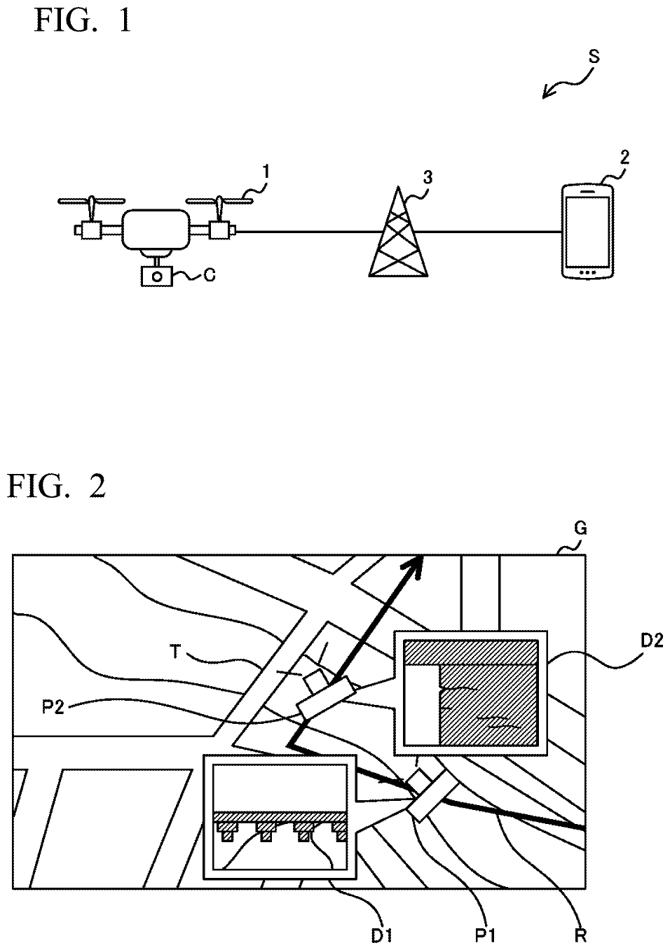

FIG. 1 is a diagram for illustrating an outline of an information display system S. The information display system S is a system for displaying information acquired by a sensor of a flight device. The information display system S is used for, for example, inspection and monitoring of equipment. The information display system S includes a flight device 1 and an information display device 2.

The flight device 1 is, for example, a drone. The flight device 1 includes a sensor C. The flight device 1 may include one sensor C or a plurality of sensors C. The sensor C is a device that performs sensing on a sensing object to be sensed, and is, for example, a camera, a microphone (for example, a directional microphone), a distance sensor (for example, a laser), or the like. When the sensor C is a camera, the sensing object is a subject of the captured image, when the sensor C is a microphone, the sensing object is a source of sound, and when the sensor C is a distance sensor, the sensing target is an object that exists in a direction in which the sensor C is facing. The flight device 1 transmits various information including sensing data acquired by sensing by the sensor C to the information display device 2. The sensing data is, for example, an image captured by a camera, a sound collected by a microphone, information measured by a distance sensor, information indicating a distance from the sensor C to an object, and the like.

The information display device 2 is, for example, a smartphone, a controller including a display, a personal computer, or the like. For example, the information display device 2 communicates with the flight device 1 via a base station 3 of a mobile phone network, and displays the information transmitted by the flight device 1.

FIG. 2 is a diagram schematically illustrating information displayed on the information display device 2. In an example illustrated in FIG. 2, information sensed by the sensor C of the flight device 1 is displayed on a route R where a user using the information display system S has flown the flight device 1 for inspecting a bridge. An image D1 is an image captured by the sensor C of the flight device 1 at a position P1, and an image D2 is an image captured by the sensor C of the flight device 1 at a position P2. An object T is a sensing object, for example, a bridge. The object T may be part of a bridge (for example, a pier). An image G is a terrain image. Examples of the terrain images include artifacts such as buildings and roads. The terrain image is an image in a range including at least a position where sensing data is acquired. The terrain image may be an image in a range further including a position where the sensing object exists. In FIG. 2, information indicating a position where each image including the object T is captured (camera mark indicating each position) and information indicating from which direction each image is captured (orientation of the camera mark) are displayed to be superimposed on the image G.

For example, since a plurality of piers are provided on a bridge, it may not be possible to grasp, only using the captured image, which of the plurality of piers is the pier appearing in the captured image. Therefore, the information display system S displays, together with the captured image, information indicating from which direction the captured image is captured, in addition to the information indicating the position where the captured image is captured, as illustrated in FIG. 2. By doing so, the user who uses the information display system S can grasp where the subject appearing in the captured image exists.

In order to display the information as illustrated in FIG. 2, the information display device 2 acquires, from the flight device 1, the sensing data, an acquisition position where the sensing data is acquired, and directional information for indicating a direction of the sensing object to be sensed by the sensor C when the sensing data is acquired. The acquisition position is, for example, information indicating position coordinates. When the sensor C is a device fixed to the flight device 1, the directional information is information indicating an orientation of the flight device 1, and when the sensor C is a device which is driven laterally, the directional information is information including the orientation of the flight device 1 and an orientation of the sensor C. For example, when the flight device 1 includes a plurality of sensors C, the directional information may further include information for identifying the sensed sensor C among the plurality of sensors C.

The information display device 2 displays the sensing data, the acquisition position, and the directional information so as to be superimposed on the terrain image corresponding to the acquisition position in a form in which the direction of the sensing object on the terrain image specified by the directional information is recognizable. The terrain image corresponding to the acquisition position may be at least an image showing a predetermined range of a terrain based on the acquisition position and may be an image showing a terrain in a range including a flight route where the flight device 1 has flown.

In an example illustrated in FIG. 2, the information display device 2 displays a camera mark displayed in an orientation based on the position P1, the image D1 showing the sensing data corresponding to the position P1 (sensing data including the object T), and the directional information corresponding to the position P1, and a camera mark displayed in an orientation based on the position P2, the image D2 showing the sensing data corresponding to the position P2 (sensing data including the object T), and the directional information corresponding to the position P2, so that the camera marks are superimposed on the image G corresponding to the position P1 and position P2 indicating the acquisition position.

Hereinafter, a configuration of the information display device 2 will be described.

### Configuration of Information Display Device 2

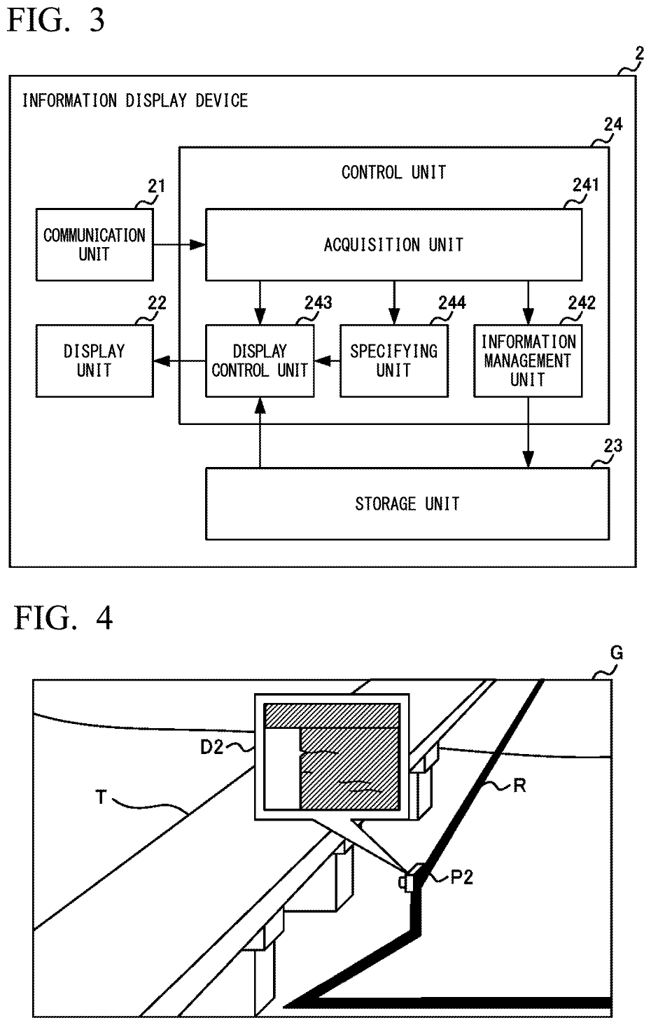

FIG. 3 is a diagram illustrating a configuration of the information display device 2. The information display device 2 includes a communication unit 21, a display unit 22, a storage unit 23, and a control unit 24. The control unit 24 includes an acquisition unit 241, an information management unit 242, a display control unit 243, and a specifying unit 244.

The communication unit 21 is an interface for communicating with the flight device 1 via the base station 3. The communication unit 21 has, for example, a local area network (LAN) controller for being connected to the Internet. The display unit 22 is a display that displays various information. The display unit 22 displays, for example, the information received from the flight device 1.

The storage unit 23 is a storage medium such as a read only memory (ROM), a random access memory (RAM), and a hard disk. The storage unit 23 stores a program executed by the control unit 24. The storage unit 23 stores at least a terrain image around the flight route where the flight device 1 flies. The terrain image is either a map data display image or a computer graphics display image.

The control unit 24 is, for example, a central processing unit (CPU). The control unit 24 functions as the acquisition unit 241, the information management unit 242, the display control unit 243, and the specifying unit 244 by executing the program stored in the storage unit 23.

The acquisition unit 241 acquires, via the communication unit 21, the sensing data acquired by the sensor C provided in the flight device 1, the acquisition position where the sensing data is acquired, and the directional information for indicating the direction of the sensing object to be sensed by the sensor C when the sensing data is acquired. The acquisition unit 241 may acquire the information from the flight device 1 in flight on the flight route or may acquire the information from the flight device 1 after flight on the flight route.

The information management unit 242 manages the information acquired by the acquisition unit 241 from the flight device 1. Specifically, the information management unit 242 causes the storage unit 23 to store the sensing data, the acquisition position, and the directional information in association with each other. Furthermore, the information management unit 242 may allow the storage unit 23 to store the sensed date and time by being associated with each other.

The information management unit 242 may collect information in real time from the flight device 1 in flight. Specifically, first, the acquisition unit 241 acquires the sensing data, the acquisition position, and the directional information from the flight device 1 in flight. Then, the information management unit 242 allows the storage unit 23 to store the sensing data, the acquisition position, and the directional information in association with each other. The information management unit 242 may collect the information accumulated during the flight of the flight device 1 after the flight device 1 has flown on the flight route.

The display control unit 243 causes the display unit 22 to display the sensing data and the directional information in association with the acquisition position. Specifically, the display control unit 243 causes the display unit 22 to display the sensing data, the acquisition position, and the directional information so as to be superimposed on the terrain image corresponding to the acquisition position in a form in which the direction of the sensing object on the terrain image specified by the directional information is recognizable.

More specifically, the display control unit 243 causes the display unit 22 to display the sensing data and the directional information in correspondence with the acquisition position. In an example illustrated in FIG. 2, the information display device 2 displays a camera mark displayed in an orientation based on the position P1, the image D1 showing the sensing data corresponding to the position P1 (sensing data including the object T), and the directional information corresponding to the position P1, and a camera mark displayed in an orientation based on the position P2, the image D2 showing the sensing data corresponding to the position P2 (sensing data including the object T), and the directional information corresponding to the position P2, so that the camera marks are superimposed on the image G corresponding to the position P1 and position P2 indicating the acquisition position. By doing so, the information display device 2 can easily grasp the sensed information visually.

The display control unit 243 may superimpose the sensing data sensed by a specific sensing object on the terrain image and cause the display unit 22 to display the sensing data among the plurality of sensing data acquired by the acquisition unit 241. For example, the information display device 2 is preset with information indicating a specific sensing object input by the user. For example, it is assumed that the specific sensing object is a “bridge”, and the plurality of sensing data acquired by the acquisition unit 241 include sensing data including a bridge and sensing data not including a bridge.

In this case, first, the display control unit 243 specifies the sensing data in which the “bridge”, which is the sensing object, is sensed, among the plurality of sensing data acquired by the acquisition unit 241. The display control unit 243 specifies sensing data that may include the specific sensing object, for example, based on a position where the specific sensing object exists on the terrain image, the acquisition position, and the directional information. The display control unit 243 may specify the sensing data including the specific sensing object by performing image analysis on each sensing data. Then, the display control unit 243 causes the display unit 22 to display the sensing data, the acquisition position, and the directional information so as to be superimposed on the terrain image corresponding to the acquisition position corresponding to the specified sensing data in a form in which the direction of the sensing object on the terrain image specified by the directional information is recognizable. By doing so, the information display device 2 can display the sensing data including the specific sensing object that the user wants to display among the plurality of acquired sensing data.

In addition to the information, the display control unit 243 may cause the display unit 22 to further display various information. For example, the display control unit 243 may cause the display unit 22 to further display latitude, longitude, and altitude indicated by the acquisition position.

For example, the display control unit 243 may cause the display unit 22 to display the flight route in a further superimposed manner. Specifically, first, the acquisition unit 241 further acquires information indicating the flight route where the flight device 1 has flown. For example, the acquisition unit 241 acquires information indicating the flight route by acquiring the information indicating the position where the flight device 1 exists at a predetermined interval from the flight device 1 flying on the flight route. For example, the storage unit 23 stores information indicating the flight route set in the flight device 1, and the acquisition unit 241 reads the information stored in the storage unit 23 to acquire the information indicating the flight route. Then, the display control unit 243 causes the display unit 22 to display the flight route so as to be further superimposed on the terrain image. By doing so, the user can easily grasp at which position on the flight route the sensing data is sensed.

The display control unit 243 may cause the display unit 22 to display the flight route in a three-dimensional manner. Specifically, the display control unit 243 causes the display unit 22 to display the sensing data, the acquisition position, the directional information, and the flight route so as to be superimposed on the three-dimensional terrain image corresponding to the acquisition position in a form in which the direction of the sensing object on the terrain image specified by the directional information is recognizable.

FIG. 4 is a diagram schematically illustrating information displayed on the information display device 2. In an example illustrated in FIG. 4, a part of the information illustrated in FIG. 2 (information around the position P2) is displayed. As illustrated in FIG. 4, the display control unit 243 causes the display unit 22 to display the image D2 showing the sensing data, the position P2 showing the acquisition position, the orientation of the camera mark of the position P2 showing the directional information, and a route R showing the flight route, so that the image D2, the position P2, the orientation, and the route R are superimposed on the three-dimensional terrain image. By doing so, the information display device 2 can more easily grasp the sensed information.

Returning to FIG. 3, the display control unit 243 may cause the display unit 22 to further display information on the sensing object, for example, the subject. The information on the subject is, for example, the name of the subject (for example, a name for identifying a specific pier among a plurality of piers) or the like. For example, the storage unit 23 stores information on an object that can be a subject on the flight route in association with the position coordinates where the object exists.

In this case, first, the specifying unit 244 specifies an imaging range of the captured image based on the acquisition position and the directional information. Then, the display control unit 243 specifies an object stored in the storage unit 23 in association with the position coordinates included in the imaging range specified by the specifying unit 244 as an object existing in the imaging range and causes the display unit 22 to further display information on the object as information on the subject. By doing so, the user can easily grasp the subject appearing in the captured image.

When the sensor C of the flight device 1 acquires a plurality of sensing data at one acquisition position, the display control unit 243 may display the plurality of sensing data in association with one acquisition position. Specifically, first, the acquisition unit 241 acquires the plurality of sensing data, one acquisition position corresponding to the plurality of sensing data, and the plurality of directional information corresponding to each of the plurality of sensing data. Then, the display control unit 243 causes the display unit 22 to display the plurality of sensing data and a plurality of directional information in association with the acquisition position.

For example, the display control unit 243 causes the display unit 22 to display the plurality of sensing data, one acquisition position, and the plurality of directional information so as to be superimposed on the terrain image corresponding to the acquisition position in a form in which the direction of the sensing object on the terrain image specified by the directional information corresponding to the sensing data is recognizable for each sensing data. By doing so, the user can grasp that the plurality of sensing data have been sensed at a certain position. The display control unit 243 may cause the display unit 22 to display any one of the plurality of sensing data in association with the acquisition position.

The display control unit 243 may cause the display unit 22 to further display at least one of the weather and state of the flight device 1 when the sensing data is acquired. An example of the weather when the sensing data is acquired is the weather, and examples of the state of the flight device 1 when the sensing data is acquired is the orientation of the flight device 1, the speed of the flight device 1, and the like. For example, when the display control unit 243 causes the display unit 22 to further display the weather, the acquisition unit 241 first acquires environmental information indicating the weather when the sensing data is acquired. In addition to the weather, the environmental information may further include temperature, humidity, atmospheric pressure, and the like. The acquisition unit 241 may acquire the environmental information of the corresponding time and the corresponding position corresponding to the time and position where the sensing data is acquired from the flight device 1 and may acquire the environmental information from a server (not illustrated) from which the weather forecast is provided. The corresponding time is, for example, the same time as a time when the sensing data is acquired, and the corresponding position is, for example, a position where the sensing data is acquired, an area including a position where the sensing data is acquired, or the like. Then, the display control unit 243 further causes the display unit 22 to display the environmental information acquired by the acquisition unit 241 so as to be superimposed on the terrain image. By doing so, the user can grasp a condition of the weather when the sensing data is acquired.

Furthermore, for example, when the display control unit 243 causes the display unit 22 to further display the state of the flight device 1, the acquisition unit 241 first acquires state information indicating the state of the flight device 1 when the sensing data is acquired from the flight device 1. Then, the display control unit 243 further causes the display unit 22 to display the state information acquired by the acquisition unit 241 so as to be superimposed on the terrain image. By doing so, the user can grasp the state of the flight device 1 when the sensing data is acquired.

The display control unit 243 may display the sensing data sensed by the sensor C of the flight device 1 in flight in real time. Specifically, the display control unit 243 causes the display unit 22 to display the sensing data so as to be superimposed on the terrain image, when the acquisition unit 241 acquires the sensing data, the acquisition position, and the directional information. By doing so, the user can confirm the sensed information in real time. The display control unit 243 may cause the display unit 22 to display the sensing data, the acquisition position, and the directional information stored in the storage unit 23 by the information management unit 242 after the flight device 1 has finished flying.

### Processing of Information Display System S

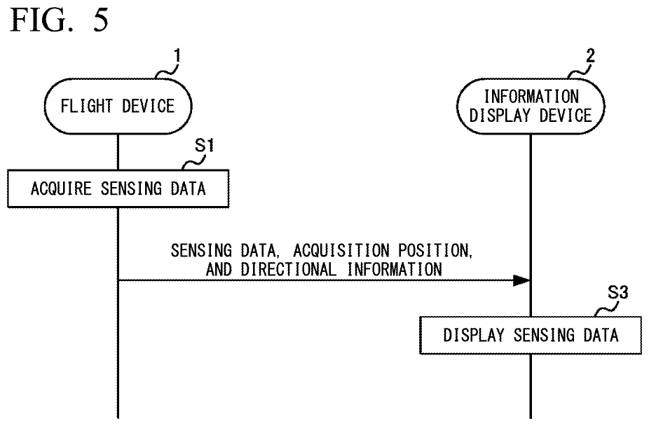

Subsequently, the processing flow of the information display system S will be described. FIG. 5 is a sequence diagram illustrating a processing flow of the information display system S. The process is started when the sensor C of the flight device 1 flying on the flight route acquires the sensing data by sensing (S1).

The flight device 1 transmits the sensing data acquired by the sensor C, the acquisition position corresponding to the sensing data, and the directional information corresponding to the sensing data to the information display device 2 via the base station 3 (S2). In the information display device 2, when the acquisition unit 241 acquires the sensing data, the acquisition position, and the directional information from the flight device 1, the display control unit 243 causes the display unit 22 to display the sensing data, the acquisition position, and the directional information so as to be superimposed on the terrain image corresponding to the acquisition position in a form in which the direction of the sensing object on the terrain image specified by the directional information is recognizable (S3).

### Effects in Present Embodiment

As described above, the information display device 2 displays the sensing data, the acquisition position, and the directional information so as to be superimposed on the terrain image corresponding to the acquisition position in a form in which the direction of the sensing object on the terrain image specified by the directional information is recognizable. By doing so, the information display device 2 can easily grasp the sensed information visually.

Although the present invention has been described above using the embodiments, the technical scope of the present invention is not limited to the scope described in the above embodiments, and various modifications and changes can be made within the scope of the gist thereof. For example, all or part of the device can be configured with any unit which is functionally or physically dispersed or integrated. Further, new embodiments generated by any combinations of the plurality of embodiments are included in the embodiments of the present invention. Further, effects of the new embodiments generated by the combinations also have the effects of the original embodiments.

What is claimed is:

1. An information display device comprising:
an acquisition unit that acquires a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; and
a display control unit that causes a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions,
wherein the display control unit causes the display unit to display the sensing data acquired by sensing the sensed object at each of the sensing positions so as to be superimposed on a terrain image corresponding to each of the sensing positions.

2. The information display device according to claim 1, wherein the display control unit causes the display unit to display the directional information for indicating the direction of the sensed object at each of the sensing positions so as to be further superimposed on the terrain image corresponding to each of the sensing positions.

3. The information display device according to claim 1, wherein the sensing data is an image captured by the sensor.

4. The information display device according to claim 1, wherein the sensing data includes information measured by the sensor and indicating a distance from the sensor to the sensed object.

5. The information display device according to claim 1, wherein:
the acquisition unit acquires the sensing data, the sensing positions at which the sensing data are acquired and the directional information from the flying device while the flying device flies; and
the display control unit causes the display unit to display the sensing data, the sensing positions and the directional information in response to the acquisition unit acquires the sensing data, the sensing positions and the directional information as a trigger.

6. The information display device according to claim 1, wherein the display control unit causes the display unit to display the sensing data acquired by sensing the sensed object specified by a user among the plurality of the sensing data.

7. The information display device according to claim 1, wherein:
the acquisition unit further acquires information indicating a flight route that the flight device has flown; and
the display control unit causes the display unit to display the flight route so as to be further superimposed on the terrain image.

8. The information display device according to claim 7, wherein the display control unit causes the display unit to display the flight route in a three-dimensional manner.

9. The information display device according to claim 1, wherein the display control unit causes the display unit to further display information relating to the sensed object.

10. The information display device according to claim 1, wherein the display control unit causes the display unit to further display latitude, longitude, and altitude indicated by each of the sensing positions.

11. The information display device according to claim 1, wherein the display control unit further causes the display unit to display at least one of weather when the sensing data is acquired and a state of the flight device.

12. The information display device according to claim 1, wherein:
the acquisition unit acquires the sensing data, the acquisition position, and the directional information from the flight device in flight, and
the information display device further comprises an information management unit that causes a storage unit to store the sensing data, the acquisition position, and the directional information in association with each other.

13. The information display device according to claim 1, wherein the terrain image is either a map data display image or a computer graphics display image.

14. An information display method executed by a computer, comprising:
acquiring a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired;
causing a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions; and
causing a display unit to display the sensing data acquired by sensing the sensed object at each of the sensing positions so as to be superimposed on a terrain image corresponding to each of the sensing positions.

15. A non-transitory computer-readable medium storing a program for causing a computer to function as:
an acquisition unit that acquires a plurality of sensing data acquired by a sensor provided on a flight device by sensing a sensed object to be sensed at a plurality of flying positions of the flight device when the flight device flies, a plurality of sensing positions at which the plurality of the sensing data are acquired, respectively, and a plurality of directional information each indicating a direction of the sensed object when each of the plurality of sensing data is acquired; and
a display control unit that causes a display unit to display the sensing data acquired by sensing the sensed object at each of the acquisition positions, and the directional information for indicating the direction of the sensed object when the sensing data is acquired at the acquisition position at each of the sensing positions, in association with each of the sensing positions,
wherein the program causes a computer to further function as the display control unit that causes the display unit to display the sensing data acquired by sensing the sensed object at each of the sensing positions so as to be superimposed on a terrain image corresponding to each of the sensing positions.
